(19) United States
(12) Patent Application Publication
(10) Pub. No.: US 2020/0310299 A1
(43) Pub. Date: Oct. 1, 2020

(54) SUCTION DEVICE AND IMAGE FORMING APPARATUS

(71) Applicant: FUJI XEROX CO., LTD., Tokyo (JP)

(72) Inventor: Daisuke UCHIMITSU, Kanagawa (JP)

(73) Assignee: FUJI XEROX CO., LTD., Tokyo (JP)

(21) Appl. No.: 16/723,786

(22) Filed: Dec. 20, 2019

(30) Foreign Application Priority Data
Apr. 1, 2019 (JP) 2019-069926

(51) Int. Cl. G03G 15/095

(52) U.S. Cl. CPC G03G 15/095

(57) ABSTRACT

A suction device includes a duct, a suction unit, and a carrier collection unit. The duct is connected to a developing device for development with a developer containing a toner and a carrier. The suction unit is connected to the duct. The suction unit includes a filter member. The carrier collection unit is provided in the duct between the developing device and the suction unit. The carrier collection unit is configured to collect the carrier.

### CROSS-REFERENCE TO RELATED APPLICATIONS

This application is based on and claims priority under 35 USC 119 from Japanese Patent Application No. 2019-069926 filed Apr. 1, 2019.

### BACKGROUND

### (i) Technical Field

The present disclosure relates to a suction device and an image forming apparatus.

### (ii) Related Art

JP-A-2010-224017 discloses a developing device for use in developing of an electrostatic latent image in an image forming apparatus that forms the electrostatic latent image on an electrostatic latent image carrier and develops the electrostatic latent image to form a toner image. The developing device includes a floating toner recovery device that recovers floating toner generated in an electrostatic latent image developing area with a filter through a suction duct. The suction duct includes a suction port and one or more toner capturing protruding portions. The suction duct suctions air from the electrostatic latent image developing area through the suction port. The toner capturing protruding portions protrude from an inner wall surface of the duct.

### SUMMARY

Aspects of non-limiting embodiments of the present disclosure relate to a suction device and an image forming apparatus that can ensure a life of a filter member provided in a suction unit even when a carrier is scattered together with a toner in a developing device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a suction device including: a duct that is connected to a developing device for development with a developer containing a toner and a carrier; a suction unit that is connected to the duct, the suction unit including a filter member; and a carrier collection unit that is provided in the duct between the developing device and the suction unit, the carrier collection unit being configured to collect the carrier.

### BRIEF DESCRIPTION OF THE DRAWINGS

Exemplary embodiment(s) of the present disclosure will be described in detail based on the following figures, wherein:

FIG. 1 is a side view showing a configuration of an image forming apparatus according to an exemplary embodiment of the present disclosure;

FIG. 2 is a vertical cross-sectional view showing a developing device used in the image forming apparatus according to the exemplary embodiment of the present disclosure;

FIG. 3 is a front cross-sectional view showing the developing device used in the image forming apparatus according to the exemplary embodiment of the present disclosure;

FIG. 4 is a plan cross-sectional view showing the developing device used in the image forming apparatus according to the exemplary embodiment of the present disclosure;

FIG. 5 is a cross-sectional view showing a suction device of a first example used in the image forming apparatus according to the exemplary embodiment of the present disclosure;

FIG. 6 is a cross-sectional view showing a suction device of a second example used in the image forming apparatus according to the exemplary embodiment of the present disclosure;

FIG. 7 is a cross-sectional view showing a suction device of a third example used in the image forming apparatus according to the exemplary embodiment of the present disclosure; and

FIG. 8 is a cross-sectional view showing a suction device of a fourth example used in the image forming apparatus according to the exemplary embodiment of the present disclosure.

### DETAILED DESCRIPTION

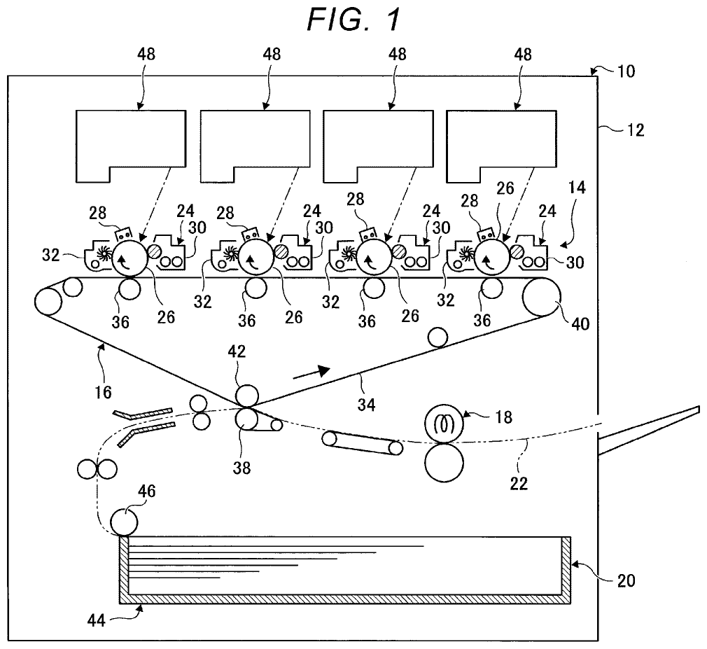

Next, exemplary embodiments of the present disclosure will be described with reference to the drawings. FIG. 1 shows an image forming apparatus 10 used in an exemplary embodiment of the present disclosure. The image forming apparatus 10 includes an image forming apparatus body 12, an image forming device 14, a transfer device 16, a fixing device 18, and a sheet feeding device 20 are disposed in the image forming apparatus body 12. Further, a transport path 22 is formed in the image forming apparatus body 12. The transport path 22 transports a recording medium such as paper.

The image forming device 14 adopts an electrophotographic system and forms an image on the recording medium. The image forming device 14 includes, for example, plural image forming units 24, for example, four image forming units. The four image forming units 24 form toner images of different colors such as yellow, magenta, cyan, and black.

The image forming unit 24 includes a photoconductor drum 26. The photoconductor drum 26 is an example of an image carrier. The photoconductor drum 26 rotates while carrying the toner image to be transferred onto the recording medium on an outer peripheral surface thereof. Further, the image forming unit 24 includes a charging device 28 that charges the photoconductor drum 26, a developing device 30 that develops a charged latent image with a toner, and a cleaning device 32 that cleans the photoconductor drum 26 after transfer. Further, an optical writing device 48 is provided that forms a latent image on the charged photoconductor drum 26.

The transfer device 16 includes an intermediate transfer belt 34. The toner images are primarily transferred onto the intermediate transfer belt 34 from the photoconductor drums 26 by primary transfer members 36, respectively. The primarily transferred toner images are secondarily transferred onto the recording medium by a secondary transfer member 38.

The intermediate transfer belt 34 is supported so as to be rotatable by plural support members 40. Further, a backup member 42 is provided that faces the secondary transfer member 38.

The fixing device 18 fixes the toner image transferred onto the recording medium to the recording medium using, for example, heat and pressure.

The sheet feeding device 20 includes a storage unit 44 that stores the stacked recording media, and a delivery member 46 that delivers the recording media stored in the storage unit 44 one by one toward the transport path 22.

The transport path 22 transports the recording medium from the sheet feeding device 20 to a place between the secondary transfer member 38 and the backup member 42, transports the recording medium to the fixing device 18, and further transports the recording medium so as to discharge the recording medium to an outside of the image forming apparatus body 12.

In the image forming apparatus 10 configured as described above, the toner images respectively formed on the outer peripheral surfaces of the photoconductor drums 26 are primarily transferred onto the intermediate transfer belt 34, the toner image primarily transferred onto the intermediate transfer belt 34 is secondarily transferred onto the recording medium, and the toner image secondarily transferred onto the recording medium is fixed on the recording medium by the fixing device 18.

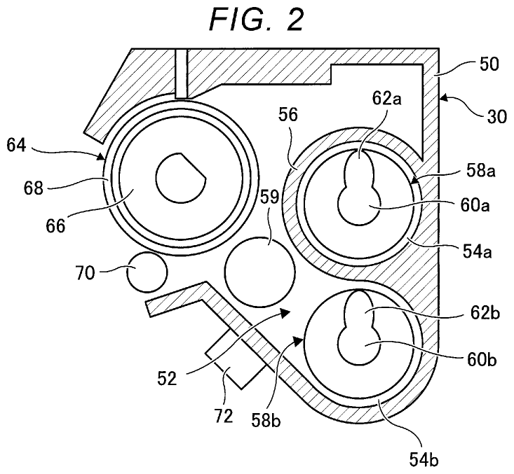

FIG. 2 shows a developer supply system.

The developing device 30 is a two-component developing device that agitates the developer containing a carrier and a toner to charge the toner for development.

The developing device 30 includes a developing device body 50. A developer transport unit 52 is provided in the developing device body 50. For example, two agitation transport paths 54a and 54b are formed in the developer transport unit 52 to extend in a longitudinal direction of the developing device body 50. The agitation transport paths 54a and 54b are divided by a partition wall 56 along a longitudinal direction. The agitation transport paths 54a and 54b are connected to each other at both ends of the agitation transport path 54a and 54b in the longitudinal direction. Agitation transport members 58a and 58b are disposed on the agitation transport paths 54a and 54b, respectively. The agitation transport members 58a and 58b includes rotation shafts 60a and 60b, and agitation transport units 62a and 62b spirally formed around the rotation shafts 60a and 60b. The developer transport unit 52 agitates and transports the developer by the rotating agitation transport members 58a and 58b to charge the carrier and the toner.

Further, a developing roller 64 is provided in the developing device body 50. The developing roller 64 includes a magnet member 66 and a sleeve 68. The magnet member 66 is fixed inside the developing roller 64 and forms magnetic poles on a peripheral surface thereof. The sleeve 68 rotates around the magnet member 66. The developing roller 64 faces the photoconductor drum 26. The toner adheres to a magnetic brush formed around the sleeve 68 is moved to the latent image formed on the photoconductor drum 26. An accumulation transport member 59 is provided between the agitation transport member 58 and the developing roller 64. The accumulation transport member 59 transports an accumulating developer to the developing roller 64. Further, a layer thickness regulating member 70 is provided in the developing device body 50. The layer thickness regulating member 70 faces the developing roller 64. The layer thickness regulating member 70 regulates a layer thickness of the magnetic brush formed on the sleeve 68. A tip end of the magnetic brush formed on the sleeve 68 comes into contact with the photoconductor drum 26, so that the latent image on the photoconductor drum 26 is developed with the toner.

A magnetic permeability sensor 72 is provided in the developing device body 50. The magnetic permeability sensor 72 measures the magnetic permeability of the carrier which is present around the magnetic permeability sensor 72. When the magnetic permeability sensor 72 detects that the amount of the carrier is large, the amount of developer is insufficient. Therefore, control is performed such that the developer is be supplied from a developer container which will be described later.

A groove is formed on a surface of the sleeve 68 of the developing roller 64 and faces an image forming portion of the photoconductor drum 26. This structure makes the sleeve 68 easily carry the magnetic brush. On the other hand, no groove is formed at both ends of the sleeve 68 in the longitudinal direction. Thus, a toner cloud is likely to occur. The toner cloud is such a phenomenon that the toner is scattered in a spray state. A suction mechanism is provided in order to prevent the toner cloud from leaking from the developing device 30 to an outside of the developing device 30.

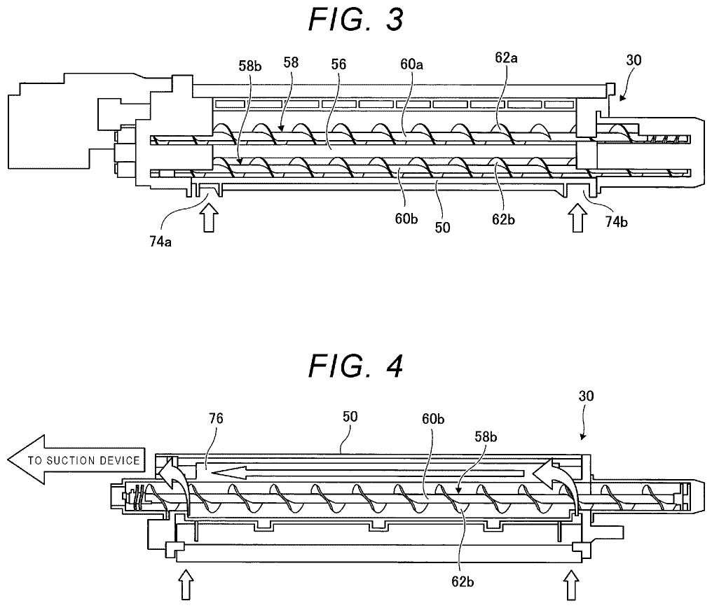

In the developing device 30, as shown in FIG. 3, the suction mechanism includes suction ports 74a and 74b at both sides of the developer device body 50 in the longitudinal direction of the developing device body 50. In the developing device body 50, as shown in FIG. 4, a suction passage 76 is formed in the vicinity of the developing roller 64 along the longitudinal direction of the developing device body 50. The suction ports 74a and 74b and the suction passage 76 are connected to each other in the vicinity of both sides of the developing roller 64, and mainly transport the toner cloud formed at both ends of the developing roller 64 to the suction passage 76.

One end of the suction passage 76 is connected to a suction device 78 to be described below.

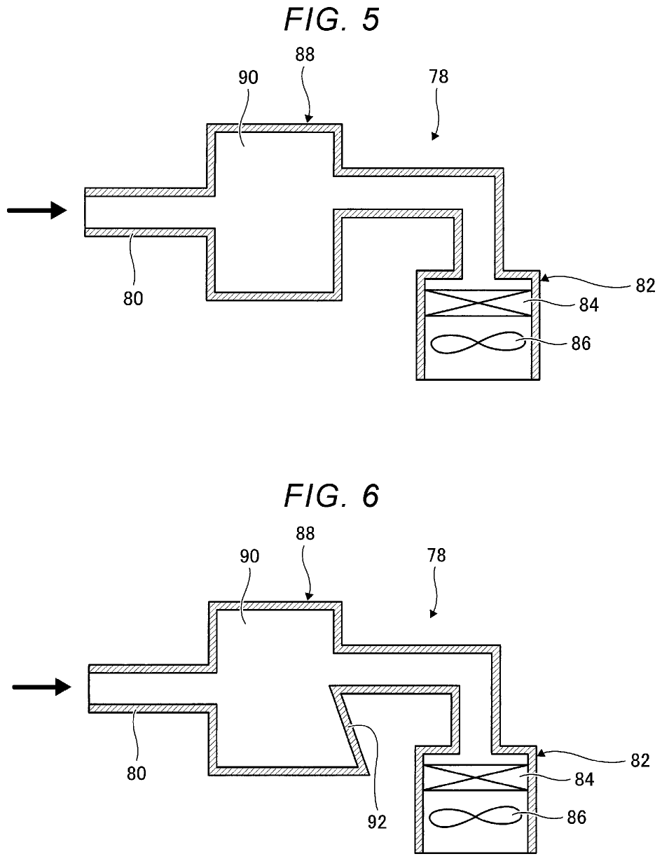

FIG. 5 shows a first example of the suction device 78.

The suction device 78 includes a duct 80. One end of the duct 80 is connected to the suction passage 76 of the developing device 30.

The term “duct” refers to a member that allows gas to pass through. Here, the duct is a member that allows the suctioned toner cloud to pass along with air.

The other end of the duct 80 is connected to a suction unit 82. The suction unit 82 includes a filter member 84 and a fan 86. The filter member 84 is made of paper, cloth, or the like, and collects the toner cloud. The fan 86 discharges the suctioned air to an outside of the image forming apparatus 10.

The filter member 84 is provided for collecting the toner cloud. The toner cloud may contain a carrier due to a reduction in the diameter of the carrier and an increase in speed for the purpose of improving productivity. In this case, not only the toner but also the carrier is collected by the filter member 84. The specific gravity of the carrier is larger than that of the toner. Thus, the weight of matters collected by the filter member 84 increases. A replacement timing of the filter member 84 is defined based on the weight of the matters collected by the filter member 84. If the filter member 84 collects the carrier, the filter member 84 needs to be replaced earlier than the defined replacement timing.

Therefore, a carrier collection unit 88 that collects the carrier is provided in the duct 80 between the developing device 30 and the suction unit 82 including the filter member 84.

In the first example of the suction device 78 shown in FIG. 5, the carrier collection unit 88 includes a space 90. The space 90 has a diameter larger than a diameter of the duct 80 on an inlet side of the space 90. When the toner cloud including the carrier enters the space 90, velocity of the toner cloud is rapidly reduced, and the carrier with a large specific gravity falls due to gravity and is collected at a lower portion of the space 90. The toner cloud from which the carrier is separated further passes through the duct 80 and is collected by the filter member 84 of the suction unit 82.

FIG. 6 shows a second example of the suction device 78.

In the second example, a protruding portion 92 protruding toward an outlet side is provided at a lower portion of an outlet side of the space 90 shown in the first example. The carrier collected in the lower portion of the space 90 enters the protruding portion 92, and the carrier is prevented from being discharged from the space 90.

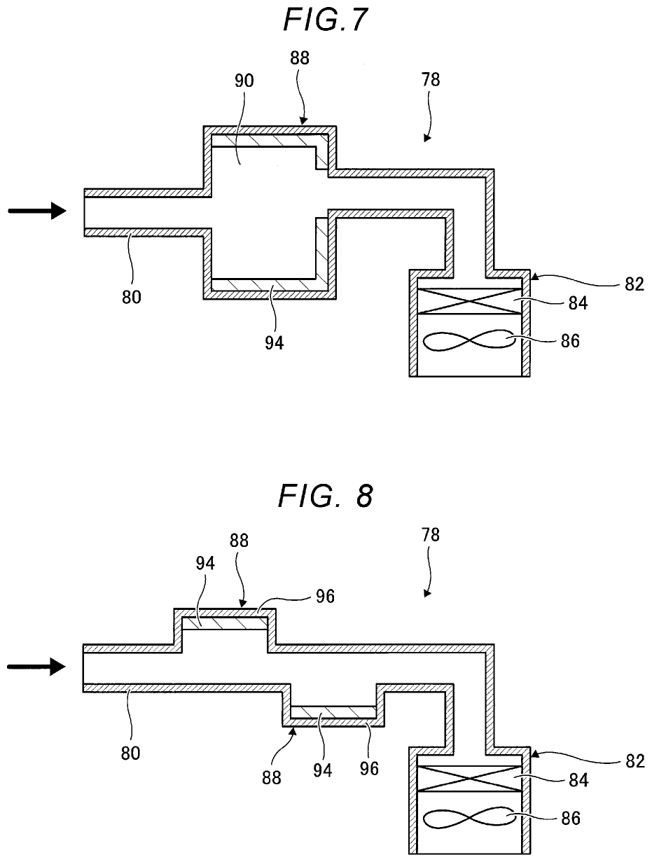

FIG. 7 shows a third example of the suction device 78.

In the third example, a magnet 94 is provided along upper and lower surfaces and side surfaces of the carrier collection unit 88 shown in the first example. The carrier entering the space 90 is adsorbed by magnetic force of the magnet 94. The magnet 94 holds the carrier in the space 90 even when the suction unit 82 suctions the carrier with suction power to some degree.

The magnet 94 may be a permanent magnet or an electromagnet.

FIG. 8 shows a fourth example of the suction device 78.

In the fourth example, the carrier collection units 88 are provided at, for example, two positions. The carrier collection units 88 of the fourth example includes the magnets 94 and magnet insertion portions 96 into which the magnets 94 are inserted. The magnet insertion portions 96 are recessed such that when the carrier is collected by the magnets 94, the diameter of the duct 80 is not narrowed by the carrier. In the fourth example, the carrier is collected by the magnetic force of the magnets 94 in the carrier collection units 88.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A suction device comprising:
a duct that is connected to a developing device for development with a developer containing a toner and a carrier,
the developing device configured to apply developer to an image carrier to form an image;
a suction unit that is connected to the duct, the suction unit comprising a filter member; and
a carrier collection unit that is provided in the duct between the developing device and the suction unit, the carrier collection unit being configured to collect the carrier.

2. The suction device according to claim 1, wherein the carrier collection unit comprises a space having a diameter larger than a diameter of the duct.

3. The suction device according to claim 2, wherein the carrier collection unit comprises a protruding portion configured such that a downstream side in an airflow direction of the space protrudes toward the suction unit.

4. The suction device according to claim 2, further comprising:
a magnet that is provided in the space, the magnet being configured to adsorb the carrier.

5. The suction device according to claim 3, further comprising:
a magnet that is provided in the space, the magnet being configured to adsorb the carrier.

6. The suction device according to claim 1, wherein the carrier collection unit comprises a magnet configured to adsorb the carrier.

7. An image forming apparatus comprising:
an image carrier on which a latent image is to be formed;
a developing device configured to develop the latent image of the image carrier; and
a suction device configured to suction a developer scattered in the developing device, wherein
the suction device comprises
a duct that is connected to the developing device;
a suction unit that is connected to the duct, the suction unit comprising a filter member; and
a carrier collection unit that is provided in the duct between the developing device and the suction unit, the carrier collection unit being configured to collect the carrier.

8. A suction device comprising:
a duct that is connected to developing means for development with a developer containing a toner and a carrier;
suction means that is connected to the duct, the suction means comprising a filter member; and
carrier collection means that is provided in the duct between the developing means and the suction means, the carrier collection means for collecting the carrier.
